(19) United States
(12) Patent Application Publication
(10) Pub. No.: US 2009/0196626 A1
(43) Pub. Date: Aug. 6, 2009

(54) Receiver optical sub-assembly and optical receiver module

(75) Inventor: Takuya Nakao, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/285,563

(22) Filed: Oct. 8, 2008

(30) Foreign Application Priority Data
Jan. 31, 2008 (JP) 2008-021603

(51) Int. Cl. H04B 10/00; G01J 1/44

(52) U.S. Cl. 398/135; 250/206

(57) ABSTRACT

A receiver optical sub-assembly includes a multilayered ceramic substrate mounted on an electrically conductive base. The multilayered ceramic substrate has a ground layer on the front surface. A light receiving element is mounted on the front surface of the multilayered ceramic substrate. A cap and the electrically conductive base enclose the multilayered ceramic substrate and the light receiving element. An electrically conductive body connects the ground layer to the electrically conductive base. Terminals are attached to the back surface of the multilayered ceramic substrate. The terminals project outside the electrically conductive base. A high frequency noise propagates from the ground layer to the base through the electrically conductive body. A sufficient amount of ground potential is obtained. Self-resonance is prevented. The multilayered ceramic substrate enables an enhanced density of the terminals based on a wiring pattern or patterns and a via or vias.

### BACKGROUND OF THE INVENTION

1. Field of the Invention

The present invention relates to a receiver optical sub-assembly suitable for a long-distance optical transmission.

2. Description of the Prior Art

An optical receiver device such as a receiver optical sub-assembly (ROSA) is well known. A photodiode is incorporated in the receiver optical sub-assembly. The photodiode outputs electric current in response to reception of light. The electric current output from the photodiode is converted into voltage through an amplifier. The output from the amplifier is utilized to discriminate the binary data of a signal. The photodiode is mounted on a glass hermetic package substrate, for example. A sealing cap is utilized to hermetically enclose the glass hermetic package substrate under a nitrogen atmosphere. A long-distance optical transmission of a transmission distance of 80 km or longer, for example, is well known. Such a long-distance optical transmission suffers from distortion of a received optical signal. Adjustment of the output waveform from the amplifier is required for discrimination of the binary data. A control signal has to be input into a reference terminal for adjustment of the output waveform. It is necessary to increase the number of the pin terminals of the optical receiver module. The glass hermetic package substrate cannot accept such an increase in the number of the pin terminals.

### SUMMARY OF THE INVENTION

It is accordingly an object of the present invention to provide a receiver optical sub-assembly accepting an increase in the number of terminals.

According to a first aspect of the present invention, there is provided a receiver optical sub-assembly comprising: an electrically conductive base; a multilayered ceramic substrate mounted on the electrically conductive base, the multilayered ceramic substrate having a ground layer on the front surface of the multilayered ceramic substrate; a light receiving element mounted on the front surface of the multilayered ceramic substrate; a cap cooperating with the electrically conductive base for enclosing the multilayered ceramic substrate and the light receiving element; an electrically conductive body connecting the ground layer to the electrically conductive base; and terminals attached to the back surface of the multilayered ceramic substrate, the terminals projecting outside the electrically conductive base.

The receiver optical sub-assembly allows the base to function as a ground. A high frequency noise propagates from the ground layer to the electrically conductive body. The high-frequency noise then propagates from the electrically conductive body to the base. A sufficient amount of ground potential is obtained. Self-resonance is prevented on the multilayered ceramic substrate. The output voltage from the pin terminals reflects the binary data of an optical signal with accuracy. The information of the optical signal is detected with accuracy. The receiver optical sub-assembly employs the multilayered ceramic substrate. The multilayered ceramic substrate enables an enhanced density of the terminals on each ceramic layer based on a wiring pattern or patterns and a via or vias. The receiver optical sub-assembly thus allows an increase in the number of the terminals as compared with a conventional one.

The cap may include: an electrically conductive cylindrical body standing from the electrically conductive base to surround the multilayered ceramic substrate and the light receiving element along the electrically conductive base, the electrically conductive cylindrical body connected to the ground layer through an electrically conductive material so as to serve as a part of the electrically conductive body; and a top plate coupled to the upper end of the electrically conductive cylindrical body, the top plate closing an opening of the cylindrical body at the upper end of the electrically conductive cylindrical body. The multilayered ceramic substrate and the light receiving element are hermetically enclosed in the cap in the receiver optical sub-assembly. When the cap is divided into the electrically conductive cylindrical body and the top plate, it is possible for an operator to observe the condition of bonding between the electrically conductive material and the ground layer as well as between the electrically conductive material and the electrically conductive cylindrical body prior to enclosing process of the multilayered ceramic substrate and the light receiving element. Electric continuity is accordingly reliably established from the ground layer to the base. In this case, the electrically conductive material may be an electrically conductive adhesive connecting the ground layer to the electrically conductive cylindrical body along the periphery of the multilayered ceramic substrate.

The receiver optical sub-assembly may further comprise an electrically conductive cylindrical member standing from the electrically conductive base within the inner space defined in the cap so as to surround the multilayered ceramic substrate and the light receiving element along the electrically conductive base, the electrically conductive cylindrical member connected to the ground layer through an electrically conductive material so as to serve as a part of the electrically conductive body. The multilayered ceramic substrate and the light receiving element are hermetically enclosed in the cap in the receiver optical sub-assembly. The cylindrical member allows an operator to observe the condition of bonding between the electrically conductive material and the ground layer as well as between the electrically conductive material and the cylindrical member prior to enclosing process of the multilayered ceramic substrate and the light receiving element. Electric continuity is accordingly reliably established from the ground layer to the base. In this case, the electrically conductive material is an electrically conductive adhesive connecting the ground layer to the electrically conductive cylindrical member along the periphery of the multilayered ceramic substrate.

The cap may be made of an electrically conductive material so as to serve as a part of the electrically conductive body, the cap being bonded to the ground layer along the periphery of the multilayered ceramic substrate through a circular solder material. The multilayered ceramic substrate and the light receiving element are hermetically enclosed in the cap in the receiver optical sub-assembly. The solder material can melt based on an applied heat even after the multilayered ceramic substrate and the light receiving element are hermetically enclosed. Solder bonding in this manner allows a reliable establishment of electrical continuity from the ground layer to the base.

The electrically conductive body may be formed on the peripheral end surface of the multilayered ceramic substrate to extend from the ground layer to the electrically conductive base. The electrically conductive body allows a reliable establishment of electrical continuity from the ground layer to the base.

The receiver optical sub-assembly can be utilized in an optical receiver module. In this case, the optical receiver module may comprise: a printed wiring board; an electrically conductive base superposed on the end surface of the printed wiring board in an attitude intersecting the printed wiring board; a multilayered ceramic substrate mounted on the surface of the electrically conductive base, the multilayered ceramic substrate having a ground layer on the front surface of the multilayered ceramic substrate; a light receiving element mounted on the front surface of the multilayered ceramic substrate; a cap cooperating with the electrically conductive base for enclosing the multilayered ceramic substrate and the light receiving element; an electrically conductive body connecting the ground layer to the electrically conductive base; and terminals attached to the back surface of the multilayered ceramic substrate, the terminals projecting outside the electrically conductive base, the terminals being bonded to the front and back surfaces of the printed wiring board outside the electrically conductive base.

The receiver optical sub-assembly can be utilized in an optical transmitter/receiver module. In this case, the optical transmitter/receiver module may comprise: a printed wiring board; a package substrate attached to the end surface of the printed wiring board in an attitude intersecting the printed wiring board; a light emitting element mounted on the surface the package substrate; an electrically conductive base superposed on the end surface of the printed wiring board in an attitude intersecting the printed wiring board; a multilayered ceramic substrate mounted on the surface of the electrically conductive base, the multilayered ceramic substrate having a ground layer on the front surface of the multilayered ceramic substrate; a light receiving element mounted on the front surface of the multilayered ceramic substrate; a cap cooperating with the electrically conductive base for enclosing the multilayered ceramic substrate and the light receiving element; an electrically conductive body connecting the ground layer to the electrically conductive base; and terminals attached to the back surface of the multilayered ceramic substrate, the terminals projecting outside the electrically conductive base, the terminals being bonded to the front and back surfaces of the printed wiring board outside the electrically conductive base.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a partial perspective view of an optical receiver module;

FIG. 2 is an enlarged sectional view taken along the line 2-2 in FIG. 1;

FIG. 3 is a sectional view taken along the line 3-3 in FIG. 2 for schematically illustrating a receiver optical sub-assembly according to a first embodiment of the present invention;

FIG. 4 is a plan view of a multilayered ceramic substrate for schematically illustrating an electrically conductive adhesive piece;

FIG. 5 is a sectional view taken along the line 5-5 in FIG. 2;

FIG. 6 is a circuit diagram of the receiver optical sub-assembly including a photodiode chip and a chip amplifier;

FIG. 7 is a graph showing the output return loss characteristics of the receiver optical sub-assembly;

FIG. 8 is a sectional view, corresponding to FIG. 3, schematically illustrating a production process of the receiver optical sub-assembly;

FIG. 9 is a sectional view, corresponding to FIG. 3, schematically illustrating a receiver optical sub-assembly according to a second embodiment of the present invention;

FIG. 10 is a sectional view, corresponding to FIG. 3, schematically illustrating a receiver optical sub-assembly according to a third embodiment of the present invention;

FIG. 11 is perspective view illustrating a circular solder material;

FIG. 12 is a sectional view, corresponding to FIG. 3, schematically illustrating a receiver optical sub-assembly according to a fourth embodiment of the present invention;

FIG. 13 is a partial perspective view of an optical transmitter/receiver module; and

FIG. 14 is a sectional view, taken in the same manner as FIG. 3, of a transmitter optical sub-assembly according to an embodiment.

### DESCRIPTION OF THE PREFERRED EMBODIMENT

FIG. 1 schematically illustrates an optical receiver module 11. The optical receiver module 11 includes a printed wiring board 12 contoured in a rectangle, for example. Wiring patterns 13 are formed on the front surface of the printed wiring board 12 and the back surface, not shown, of the printed wiring board 12. The front and back surfaces of the printed wiring board 12 extend in parallel with each other. The printed wiring board 12 defines four end surfaces perpendicular to its front and back surfaces. The four end surfaces connect the front and back surfaces to each other. A receiver optical sub-assembly (ROSA) 14 according to a first embodiment of the present invention is attached to one of the end surfaces of the printed wiring board 12.

The receiver optical sub-assembly 14 includes a base 15 in the form of a disk. The base 15 is superposed on the end surface of the printed wiring board 12. The base 15 takes an attitude intersecting the printed wiring board 12. Here, the base 15 extends along an imaginary plane perpendicular to the printed wiring board 12. The base 15 has electrical conductivity. The base 15 may be made of an alloy material such as iron nickel cobalt alloy (so-called Kovar®), for example, so as to establish the electrical conductivity of the base 15. Here, the exposed surface of the base 15 is plated with gold. A sealing cap 16 is bonded to the surface of the base 15.

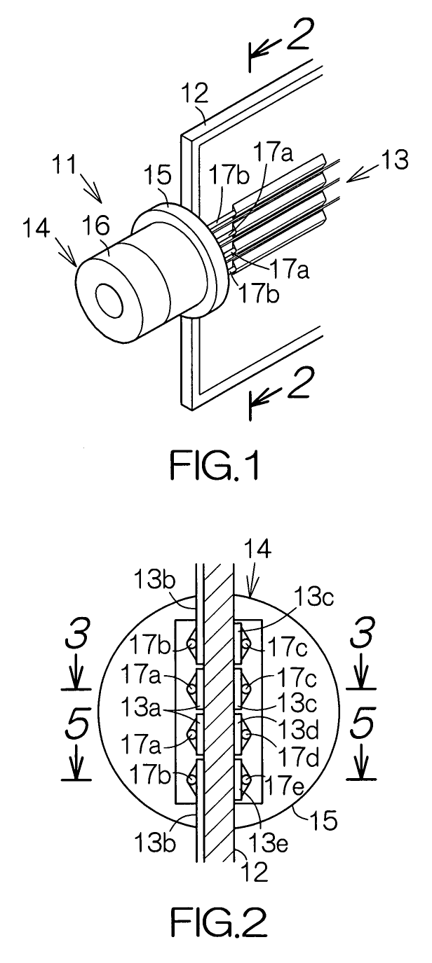

The receiver optical sub-assembly 14 includes pin terminals 17a, 17b, 17c, 17d, 17e projecting outward through the base 15. The pin terminals 17a-17e have electrical conductivity. The pin terminals 17a-17e may be made of the aforementioned iron nickel cobalt alloy, for example, so as to establish the electrical conductivity of the pin terminals 17a-17e. Four of them, the pin terminals 17a, 17b, are fixed to the front surface of the printed wiring board 12. As shown in FIG. 2, the other four of them, the pin terminals 17c, 17d, 17e, are fixed to the back surface of the printed wiring board 12.

A pair of pin terminals 17a corresponds to signal terminals, for example. The pin terminals 17a are bonded to signal wiring patterns 13a extending on the front surface of the printed wiring board 12, for example. Solder is utilized to bond the pin terminals 17a, for example. A pair of pin terminals 17b corresponds to ground terminals, for example. The pin terminals 17b are bonded to a ground wiring pattern 13b extending on the front surface of the printed wiring board 12 at positions outside the signal terminals. Solder is utilized to bond the pin terminals 17b, for example. The ground wiring pattern 13b may cover over the entire front surface of the printed wiring board 12 except an area covered with the signal wiring patterns 13a, for example. The ground wiring pattern 13b is insulated from the signal wiring patterns 13a.

A pair of pin terminals 17c corresponds to power supply terminals. The pin terminals 17c are bonded to power supply wiring patterns 13c extending on the back surface of the printed wiring board 12, for example. Solder is utilized to bond the pin terminals 17c, for example. The pin terminal 17d corresponds to a control signal terminal. The pin terminal 17d is bonded to a control signal wiring pattern 13d extending on the back surface of the printed wiring board 12. Solder is utilized to bond the pin terminal 17d, for example. The pin terminal 17e corresponds to a thermistor terminal. The pin terminal 17e is bonded to a wiring pattern 13e, leading to a thermistor, on the back surface of the printed wiring board 12. Solder is utilized to bond the pin terminal 17e, for example.

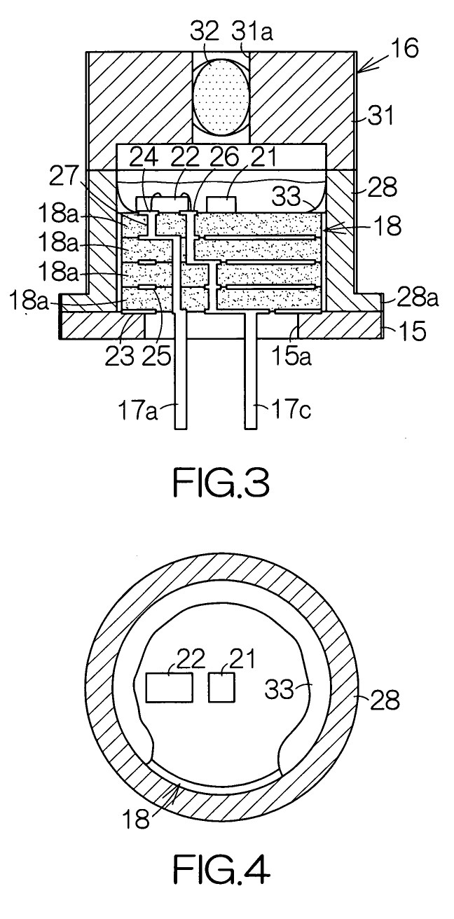

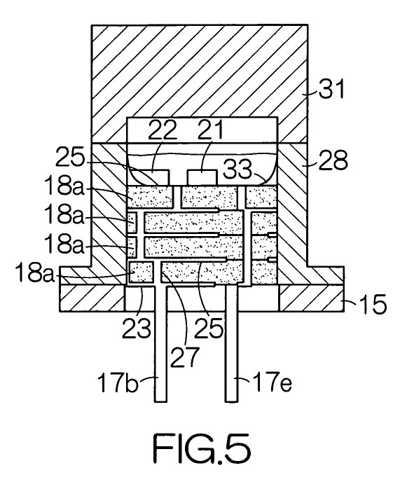

As shown in FIG. 3, a multilayered ceramic substrate 18 is mounted on the surface of the base 15. The multilayered ceramic substrate 18 is superposed on the surface of the base 15. A light receiving element, namely a photodiode (PD) chip 21, and a chip amplifier 22 are mounted on the front surface of the multilayered ceramic substrate 18. An adhesive is utilized to mount the photodiode chip 21 and the chip amplifier 22. The aforementioned pin terminals 17a-17e are fixed to the back surface of the multilayered ceramic substrate 18. Brazing is employed to fix the pin terminals 17a-17e. An opening 15a is defined in the base 15. The pin terminals 17a-17e are located in the opening 15a. The pin terminals 17a-17e thus project outside the base 15. The multilayered ceramic substrate 18 is hermetically bonded to the surface of the base 15 all around the opening 15a. Brazing is employed to bond the multilayered ceramic substrate 18, for example. A ground pattern, namely a gold plating layer 23, is formed on the back surface of the multilayered ceramic substrate 18 at a position off the pin terminals 17a-17e for receiving the brazing.

The multilayered ceramic substrate 18 includes ceramic layers 18a. Wiring patterns 24, 25 and a power supply pattern 26 are formed on the surfaces of the ceramic layers 18a. The wiring patterns include signal line patterns 24, and ground pattern 25 extending around the signal line patterns 24, for example. The ground pattern 25 may cover over the entire surface of the ceramic layer 18a except an area or areas covered with the signal line patterns 24. The terminals of the photodiode chip 21 and the chip amplifier 22 are connected to the corresponding signal line patterns 24, the corresponding power supply pattern 26 and the corresponding ground pattern 25 on the uppermost layer, respectively, for example. Wire bonding is utilized to connect the terminals, for example. The signal line patterns 24, the ground pattern 25 and the power supply pattern 26 may be established based on gold plating, for example.

A via 27 is formed in the individual ceramic layer 18a. The via 27 includes a through bore penetrating from the front surface to the back surface of the ceramic layer 18a and a conductive body located in the through bore. The signal line patterns 24 on the front surface of the multilayered ceramic substrate 18 are connected to the corresponding pin terminals 17a, respectively, through the signal line patterns 24 and the vias 27 of the lower layers. Electrical connection is in this manner established between the photodiode chip 21 and the pin terminals as well as between the chip amplifier 22 and the pin terminals.

The sealing cap 16 includes a cylindrical body 28 having an electrically conductive property. The cylindrical body 28 is a cylinder made of stainless steel, for example. The cylindrical body 28 stands upright from the surface of the base 15. The cylindrical body 28 is designed to endlessly surround the multilayered ceramic substrate 18 along the surface of the base 15. The axis of the cylindrical body 28 is set perpendicular to the surface of the base 15. An outward flange 28a is formed on the cylindrical body 28. The outward flange 28a extends outward from the lower end of the cylindrical body 28. The outward flange 28a is superposed on the surface of the base 15. The outward flange 28a is hermetically bonded to the surface of the base 15. Welding is employed to bond the outward flange 28a, for example. The multilayered ceramic substrate 18, the photodiode chip 21 and the chip amplifier 22 are completely contained in the inner space of the cylindrical body 28. The photodiode chip 21 is located on the axis of the cylindrical body 28, for example.

The sealing cap 16 also includes a top plate 31 in the form of a thick disk. The top plate 31 is bonded to the upper end of the cylindrical body 28. The top plate 31 is superposed on the upper end of the cylindrical body 28 along the periphery of the top plate 31. The top plate 31 is hermetically bonded to the cylindrical body 28. Welding is employed to bond the top plate 31, for example. The top plate 31 closes an opening defined in the upper end of the cylindrical body 28. A through hole 31a is formed in the top plate 31 along the extension of the axis of the cylindrical body 28. A lens 32 is located in the through hole 31a. The lens 32 is hermetically fitted in the through hole 31a. The aforementioned photodiode chip 21 is positioned on the optical axis of the lens 32. The lens 32 serves to direct light to the photodiode chip 21. Dry nitrogen gas is enclosed in the cylindrical body 28. The dry nitrogen gas contains almost no moisture. The enclosure of the dry nitrogen gas serves to prevent deterioration of the photodiode chip 21 and the chip amplifier 22 on the multilayered ceramic substrate 28.

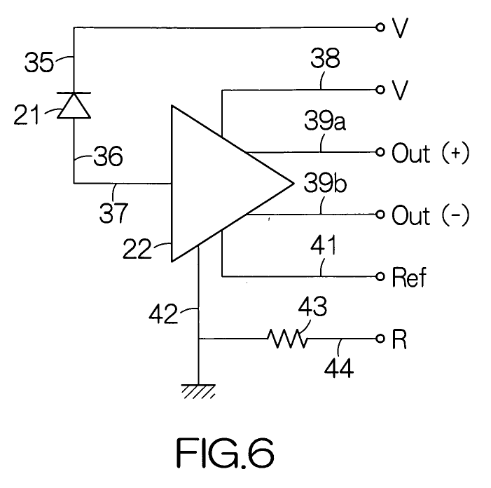

A stripe of an electrically conductive adhesive piece 33 is bonded to the front surface of the multilayered ceramic substrate 18, namely the front surface of the uppermost one of the ceramic layers 28a. The electrically conductive adhesive piece 33 extends along the periphery of the multilayered ceramic substrate 18. The electrically conductive adhesive piece 33 connects the ground pattern 25 on the front surface of the multilayered ceramic substrate 18 to the inner surface of the cylindrical body 28. In this manner, electrical continuity is established between the ground pattern 25 on the front surface of the multilayered ceramic substrate 18 and the cylindrical body 28. The electrically conductive adhesive piece 33 may be made of a thermosetting resin adhesive, for example. The thermosetting resin adhesive may include a matrix made of a thermosetting resin and electrically conductive filler, such as metal particles or carbon particles, dispersed in the matrix, for example. Here, as shown in FIG. 4, the connection between the ground pattern 25 and the inner surface of the cylindrical body 28 may be established over a range of 60% approximately or larger of the entire length of the periphery of the multilayered ceramic substrate 18, for example. As long as such a connection over a range of 60% approximately or larger is ensured, the electrically conductive adhesive piece 33 may be divided into pieces.

As shown in FIG. 5, the ground patterns 25 on the ceramic layers 18a are connected to one another through the vias 27. The individual ground pattern 25 is thus connected to the gold plating layer 23 on the back surface of the lowermost one of the ceramic layers 18a. The gold plating layer 23 is connected to the pin terminals 17b. A path of electrical connection is established from the ground terminals of the photodiode chip 21 and the chip amplifier 22 to the pin terminals 17b through the vias 27. The gold plating layer 23 also contacts with the surface of the base 15. A path of electrical connection is thus established based on the ground pattern 25 on the uppermost layer, the electrically conductive adhesive piece 33, the cylindrical body 28, the base 15 and the gold plating layer 23. The path of electrical connection is established from the ground terminals of the photodiode chip 21 and the chip amplifier 22 to the pin terminals 17b without including the vias 27.

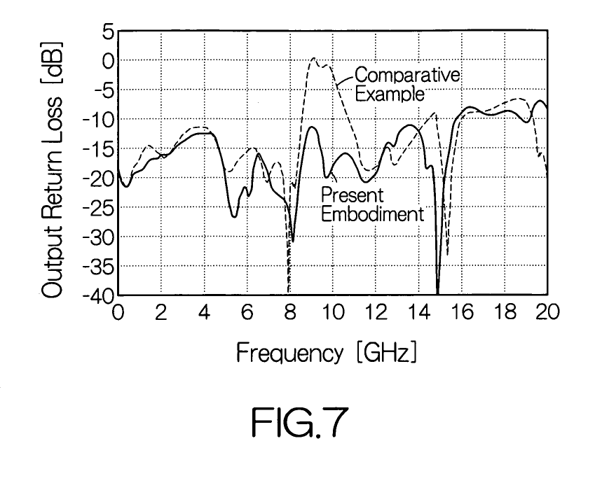

As shown in FIG. 6, a power supply terminal 35 and an output terminal 36 are mounted on the photodiode chip 21. The power supply terminal 35 is connected to the pin terminal 17c through the power supply patterns 26 and the vias 27. The output terminal 36 is connected to an input terminal 37 of the chip amplifier 22. The photodiode chip 21 outputs predetermined electric current from the output terminal 36 in response to reception of light.

A power supply terminal 38, a pair of signal terminals 39a, 39b, a reference terminal 41 and a ground terminal 42 are mounted on the chip amplifier 22. The power supply terminal 38 of the chip amplifier 22 is connected to the pin terminal 17c through the power supply patterns 26 and the vias 27. The signal terminals 39a, 39b and the reference terminal 41 are connected to the pin terminals 17a, 17a, 17d, through the signal line patterns 24 and the vias 27, respectively. The chip amplifier 22 is designed to induce a variation in voltage between the signal terminals 39a, 39b depending on the amount of electric current supplied through the input terminal 37. Here, a predetermined relationship is established between the electric current supplied through the input terminal 37 and the voltages of each of the signal terminals 39a, 39b. The relationship is adjusted based on a control signal supplied through the reference terminal 41. A thermistor 43 is connected to the ground terminal 42. An output terminal 44 of the thermistor 43 is connected to the pin terminal 17e through the signal line patterns 24 and the vias 27. The temperature of the chip amplifier 22 is specified based on a signal output from the thermistor 43. The ground terminal 42 is connected to the ground patterns 25.

Now, assume that an optical signal of 10 [Gbps] is received, for example. An optical cable, not shown, is connected to the receiver optical sub-assembly 14, for example. The tip end of the optical cable is opposed to the lens 32 on the optical axis of the lens 32. An optical signal output from the optical cable passes through the lens 32. The optical signal or light converges. The converged light is received on the photodiode chip 21. The photodiode chip 21 outputs predetermined electric current from the output terminal 36 in response to reception of the light. The amplifier chip 22 converts the electric current into voltage. A variation in the voltage is utilized to discriminate binary data of the optical signal.

In this case, a high frequency noise propagates from the amplifier chip 22 to the ground patterns 25 of the multilayered ceramic substrate 18. The high frequency noise simultaneously propagates to the pin terminals 17b not only through the vias 27 and the ground patterns 25 of the lower layers but also through the electrically conductive adhesive piece 33, the cylindrical body 28, the base 15 and the gold plating layer 23. A sufficient amount of ground potential is obtained. Self-resonance is thus prevented on the multilayered ceramic substrate 18. The output voltage from the pin terminals 17a reflects the binary data of the optical signal with accuracy. The information of the optical signal is detected with accuracy. On the other hand, in the case where the high frequency noise propagates to the pin terminals 17b only through the vias 27a and the ground patterns 25 of the lower layers, the vias 27 function as a floating capacitance or a floating inductance. The vias 27 exhibit a high impedance. It is thus impossible to obtain a sufficient amount of ground potential. The high frequency noise cannot be emitted out of the receiver optical sub-assembly 14. Self-resonance occurs on the multilayered ceramic substrate 18. The output of the pin terminals 17a cannot reflect the binary data of the optical signal with accuracy.

The present inventor measured the self-resonance of the receiver optical sub-assembly 14. The ground pattern 25 on the front surface of the multilayered ceramic substrate 18 was connected to the pin terminals 17b through the cylindrical body 28, as described above, for the measurement of the self-resonance. Electrical connection was established on the front surface of the multilayered ceramic substrate 18 along the entire periphery of the multilayered ceramic substrate 18 based on the electrically conductive adhesive piece 33 so as to connect the ground pattern 25 to the pin terminals 17b. A reflected signal was measured at the pin terminals 17a. An electric signal was input from the pin terminals 17a in a predetermined frequency range for the measurement of the reflected signal. As shown in FIG. 7, no self-resonance was observed.

The present inventor measured the self-resonance of a receiver optical sub-assembly according to a comparative example. Electrical continuity was not established between the ground pattern 25 and the cylindrical body 28 in the comparative example. In other words, the ground pattern 25 on the front surface of the multilayered ceramic substrate 18 is connected to the pin terminal 17b only through the vias 27 and the ground patterns 25 of the lower layers. A remaining structure in the comparative example was set identical to the structure according to the embodiment of the present invention. A reflected signal was measured at the pin terminals 17a in the same manner as described above. As shown in FIG. 7, suppression of return loss, namely self-resonance, was observed at 10 [GHz].

Next, a brief description will be made on a method of making the receiver optical sub-assembly 14. The multilayered ceramic substrate 18 is first prepared. The pin terminals 17a-17e are brazed to the back surface of the multilayered ceramic substrate 18. The base 15 is subsequently brazed to the back surface of the multilayered ceramic substrate 18. The multilayered ceramic substrate 18 is hermetically bonded to the base 15 all along the entire edge of the opening 15a. The photodiode chip 21 and the chip amplifier 22 are mounted on the front surface of the multilayered ceramic substrate 18. Electrical connection is established based on wire bonding.

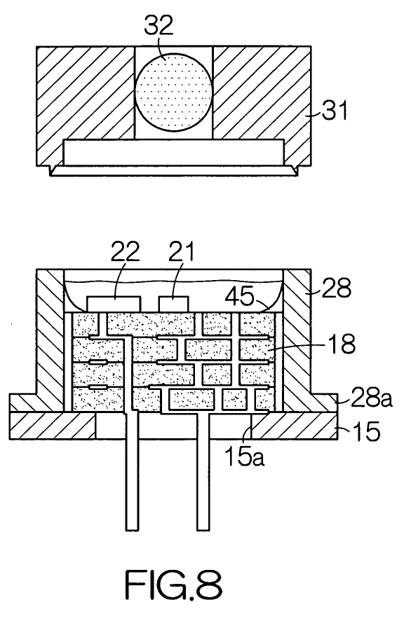

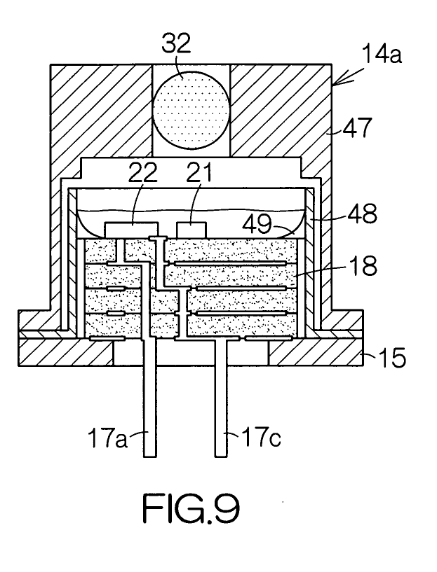

As shown in FIG. 8, the sealing cap 16 is prepared. The sealing cap 16 has been divided into the cylindrical body 28 and the top plate 31. The lens 32 has been hermetically fitted in the through hole 31a of the top plate 31. The cylindrical body 28 is fixed to the surface of the base 15. Welding is employed to fix the cylindrical body 28. The outward flange 28a of the cylindrical body 28 is hermetically bonded to the base 15 all along the entire periphery of the outward flange 28a.

The ground pattern 25 on the front surface of the multilayered ceramic substrate 18 is then coupled to the cylindrical body 28. An electrically conductive adhesive 45 is applied to the front surface of the multilayered ceramic substrate 18 along the periphery of the front surface of the multilayered ceramic substrate 18 over 60% approximately or larger of the entire length of the periphery. The electrically conductive adhesive 45 is subjected to heating process so that the electrically conductive adhesive 45 is cured or hardened. The electrically conductive adhesive piece 33 is in this manner formed. An operator can see the condition of bonding of the electrically conductive adhesive piece 33.

The top plate 31 is finally fixed to the cylindrical body 28. Welding is employed to fix the top plate 31. The top plate 31 is hermetically bonded to the cylindrical body 28 over the entire length of the periphery of the cylindrical body 28. The opening of the cylindrical body 28 is thus closed. The top plate 31 of the sealing cap 16 and the assembly of the base 15, the multilayered ceramic substrate 18 and the cylindrical body 28 are placed in the atmosphere of a dry nitrogen gas. The dry nitrogen gas contains almost no moisture. When the top plate 31 is bonded to the cylindrical body 28, the dry nitrogen gas is sealed within the inner space of the cylindrical body 28.

FIG. 9 illustrates a receiver optical sub-assembly 14a according to a second embodiment of the present invention. The receiver optical sub-assembly 14a includes a sealing cap 47 coupled to the base 15. The sealing cap 47 cooperates with the base 15 for defining a sealed inner space. The sealing cap 47 has the structure identical to the structure of the aforementioned sealing cap 16, except that the top plate 31 is formed integral with the cylindrical body 28 in the sealing cap 47. A cylindrical body 48 having an electrically conductive property is placed in the inner space of the sealing cap 47. The cylindrical body 48 has the structure identical to the structure of the aforementioned cylindrical body 28. An electrically conductive adhesive piece 49 connects the ground pattern 25 on the front surface of the multilayered ceramic substrate 18 to the cylindrical body 48. The electrically conductive adhesive piece 49 has the structure identical to the structure of the aforementioned electrically conductive adhesive piece 33. Like reference numerals are attached to the structure or components equivalent to those of the aforementioned first embodiment.

The receiver optical sub-assembly 14a is allowed to enjoy the advantages identical to those obtained in the aforementioned receiver optical sub-assembly 14. Specifically, a high frequency noise propagates to the pin terminals 17b not only through the vias 27 and the ground patterns 25 of the lower layers but also through the electrically conductive adhesive piece 49, the cylindrical body 48, the base 15 and the gold plating layer 23. A sufficient amount of ground potential is obtained. Self-resonance is thus prevented. The output voltage from the pin terminals 17a reflects the binary data of the optical signal with accuracy. The information of the optical signal is detected with accuracy.

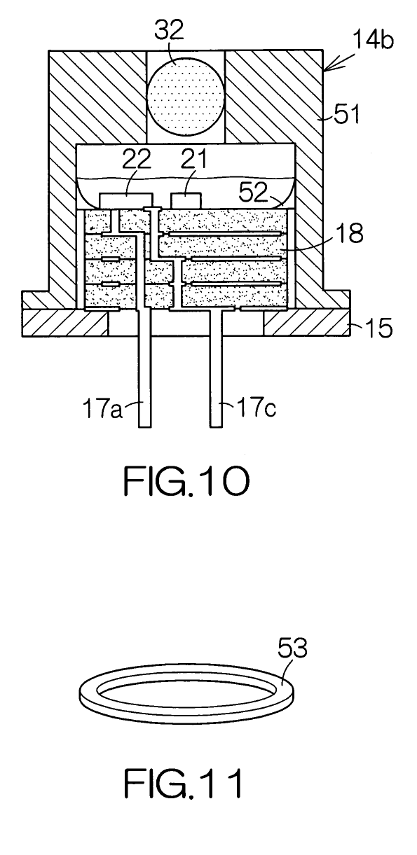

FIG. 10 illustrates a receiver optical sub-assembly 14b according to a third embodiment of the present invention. The receiver optical sub-assembly 14b includes a sealing cap 51 coupled to the base 15. The sealing cap 51 cooperates with the base 15 for defining a sealed inner space. The sealing cap 51 has the structure identical to the structure of the aforementioned sealing cap 47. A circular solder piece 52 connects the ground pattern 25 on the front surface of the multilayered ceramic substrate 18 to the inner surface of the sealing cap 51. The circular solder piece 52 is superposed on the periphery of the front surface of the multilayered ceramic substrate 18. It should be noted that a gap may be formed in the circular solder piece 51 at one point. Like reference numerals are attached to the structure or components equivalent to those of the aforementioned first and second embodiments.

The receiver optical sub-assembly 14b is allowed to enjoy the advantages identical to those obtained in the aforementioned receiver optical sub-assemblies 14, 14a. Specifically, a high frequency noise propagates to the pin terminals 17b not only through the vias 27 and the ground patterns 25 of the lower layers but also through the circular solder piece 52, the sealing cap 51, the base 15 and the gold plating layer 23. A sufficient amount of ground potential is obtained. Self-resonance is thus prevented. The output voltage from the pin terminals 17a reflects the binary data of the optical signal with accuracy. The information of the optical signal is detected with accuracy.

The multilayered ceramic substrate 18 is fixed to the surface of the base 15 in the same manner as described above in the production of the receiver optical sub-assembly 14b. A circular solder material 53 is prepared as shown in FIG. 11. The circular solder material 53 is set on the front surface of the multilayered ceramic substrate 18. A gap may be formed in the circular solder material 53. The sealing cap 51 is put on the surface of the base 15. The multilayered ceramic substrate 18 and the circular solder material 53 are contained in the inner space of the sealing cap 51. The sealing cap 51 is then fixed to the surface of the base 15. Welding is employed to fix the sealing cap 51. The flange of the sealing cap 51 is hermetically bonded to the base 15 over the entire length of the periphery of the sealing cap 51. During the welding process, the sealing cap 51 and the assembly of the base 15 and the multilayered ceramic substrate 18 are placed within the atmosphere of a dry nitrogen gas. The dry nitrogen gas contains almost no moisture. When the sealing cap 51 is bonded to the base 15, the dry nitrogen gas is sealed within the sealing cap 51. The sealing cap 51 is then subjected to heating process. The circular solder material 53 thus melts. The circular solder material 53 is then cured or hardened based on cooling process. The circular solder piece 52 is in this manner formed.

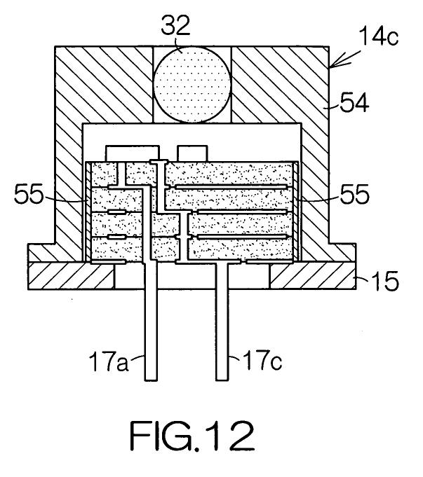

FIG. 12 illustrates a receiver optical sub-assembly 14c according to a fourth embodiment of the present invention. The receiver optical sub-assembly 14c includes a sealing cap 54 coupled to the base 15. The sealing cap 54 cooperates with the base 15 for defining a sealed inner space. The sealing cap 54 has the structure identical to the structure of the aforementioned sealing caps 47, 51. An electrically conductive film 55 such as a gold plating film is formed on the peripheral end surface of the multilayered ceramic substrate 18. The electrically conductive film 55 connects the ground pattern on the front surface of the multilayered ceramic substrate 18 to the gold plating film 23 on the back surface of the multilayered ceramic substrate 18. Like reference numerals are attached to the structure or components equivalent to those of the aforementioned first, second and third embodiments.

The receiver optical sub-assembly 14c is allowed to enjoy the advantages identical to those obtained in the aforementioned receiver optical, sub-assemblies 14, 14a, 14b. Specifically, a high frequency noise propagates to the pin terminals 17b not only through the vias 27 and the ground patterns 25 of the lower layers but also through the electrically conductive film 55. A sufficient amount of ground potential is obtained. Self-resonance is thus prevented. The output voltage from the pin terminals 17a reflects the binary data of the optical signal with accuracy. The information of the optical signal is detected with accuracy.

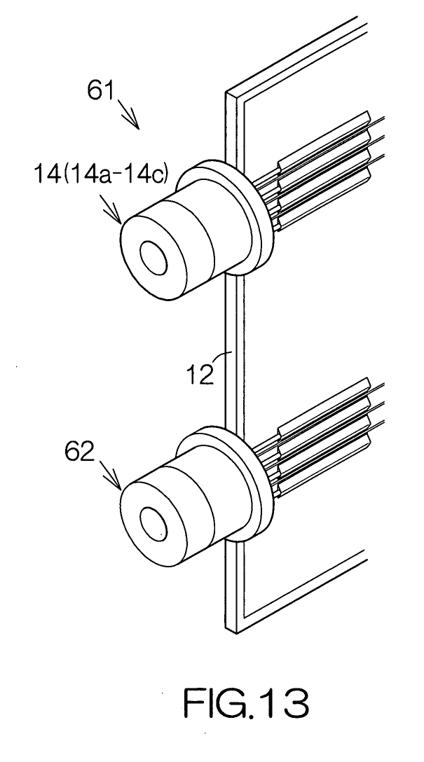

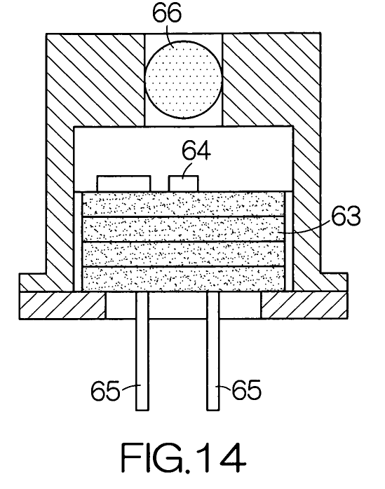

The receiver optical sub-assemblies 14, 14a, 14b, 14c allow replacement of the gold plating layer or film with an electrically conductive metal layer or film and other kind of electrically conductive layer or film. The receiver optical sub-assemblies 14, 14a, 14b, 14c may be incorporated in an optical transmitter/receiver module 61. As shown in FIG. 13, for example, the optical transmitter/receiver module 61 may include a transmitter optical sub-assembly 62 in addition to one of the aforementioned receiver optical sub-assemblies 14, 14a, 14b, 14c. The transmitter optical sub-assembly 62 includes a package substrate attached to the end surface of the printed wiring board 12. The package substrate takes an attitude intersecting the printed wiring board 12, in this case at right angles. As shown in FIG. 14, a light-emitting element such as a light emitting diode 64 is mounted on the front surface of the package substrate 63, for example. The light-emitting diode 64 emits light in response to electric current supplied from a pair of pin terminals 65, 65, for example. The light from the light-emitting diode 64 passes through a lens 66. A parallel light is output from the lens 66. The transmitter optical sub-assembly 62 may be a conventional transmitter optical sub-assembly.

What is claimed is:

1. A receiver optical sub-assembly comprising:
an electrically conductive base;
a multilayered ceramic substrate mounted on the electrically conductive base, the multilayered ceramic substrate having a ground layer on a front surface of the multilayered ceramic substrate;
a light receiving element mounted on the front surface of the multilayered ceramic substrate;
a cap cooperating with the electrically conductive base for enclosing the multilayered ceramic substrate and the light receiving element;
an electrically conductive body connecting the ground layer to the electrically conductive base; and
terminals attached to a back surface of the multilayered ceramic substrate, the terminals projecting outside the electrically conductive base.

2. The receiver optical sub-assembly according to claim 1, wherein the cap includes:
an electrically conductive cylindrical body standing from the electrically conductive base to surround the multilayered ceramic substrate and the light receiving element along the electrically conductive base, the electrically conductive cylindrical body connected to the ground layer through an electrically conductive material so as to serve as a part of the electrically conductive body; and
a top plate coupled to an upper end of the electrically conductive cylindrical body, the top plate closing an opening of the cylindrical body at the upper end of the electrically conductive cylindrical body.

3. The receiver optical sub-assembly according to claim 2, wherein the electrically conductive material is an electrically conductive adhesive connecting the ground layer to the electrically conductive cylindrical body along a periphery of the multilayered ceramic substrate.

4. The receiver optical sub-assembly according to claim 1, further comprising an electrically conductive cylindrical member standing from the electrically conductive base within an inner space defined in the cap so as to surround the multilayered ceramic substrate and the light receiving element along the electrically conductive base, the electrically conductive cylindrical member connected to the ground layer through an electrically conductive material so as to serve as a part of the electrically conductive body.

5. The receiver optical sub-assembly according to claim 4, wherein the electrically conductive material is an electrically conductive adhesive connecting the ground layer to the electrically conductive cylindrical member along a periphery of the multilayered ceramic substrate.

6. The receiver optical sub-assembly according to claim 1, wherein the cap is made of an electrically conductive material so as to serve as a part of the electrically conductive body, the cap being bonded to the ground layer along a periphery of the multilayered ceramic substrate through a circular solder material.

7. The receiver optical sub-assembly according to claim 1, wherein the electrically conductive body is formed on a peripheral end surface of the multilayered ceramic substrate to extend from the ground layer to the electrically conductive base.

8. An optical receiver module comprising:
a printed wiring board;
an electrically conductive base superposed on an end surface of the printed wiring board in an attitude intersecting the printed wiring board;
a multilayered ceramic substrate mounted on a surface of the electrically conductive base, the multilayered ceramic substrate having a ground layer on a front surface of the multilayered ceramic substrate;
a light receiving element mounted on the front surface of the multilayered ceramic substrate;
a cap cooperating with the electrically conductive base for enclosing the multilayered ceramic substrate and the light receiving element;
an electrically conductive body connecting the ground layer to the electrically conductive base; and
terminals attached to a back surface of the multilayered ceramic substrate, the terminals projecting outside the electrically conductive base, the terminals being bonded to front and back surfaces of the printed wiring board outside the electrically conductive base.

9. The optical receiver module according to claim 8, wherein the cap includes:
an electrically conductive cylindrical body standing from the electrically conductive base to surround the multilayered ceramic substrate and the light receiving element along the electrically conductive base, the electrically conductive cylindrical body connected to the ground layer through an electrically conductive material so as to serve as a part of the electrically conductive body; and
a top plate coupled to an upper end of the electrically conductive cylindrical body, the top plate closing an opening of the cylindrical body at the upper end of the electrically conductive cylindrical body.

10. The optical receiver module according to claim 9, wherein the electrically conductive material is an electrically conductive adhesive connecting the ground layer to the electrically conductive cylindrical body along a periphery of the multilayered ceramic substrate.

11. The optical receiver module according to claim 8, further comprising an electrically conductive cylindrical member standing from the electrically conductive base within an inner space defined in the cap so as to surround the multilayered ceramic substrate and the light receiving element along the electrically conductive base, the electrically conductive cylindrical member connected to the ground layer through an electrically conductive material so as to serve as a part of the electrically conductive body.

12. The optical receiver module according to claim 11, wherein the electrically conductive material is an electrically conductive adhesive connecting the ground layer to the electrically conductive cylindrical member along a periphery of the multilayered ceramic substrate.

13. The optical receiver module according to claim 8, wherein the cap is made of an electrically conductive material so as to serve as a part of the electrically conductive body, the cap being bonded to the ground layer along a periphery of the multilayered ceramic substrate through a circular solder material.

14. The optical receiver module according to claim 8, wherein the electrically conductive body is formed on a peripheral end surface of the multilayered ceramic substrate to extend from the ground layer to the electrically conductive base.

15. An optical transmitter/receiver module comprising:
a printed wiring board;
a package substrate attached to an end surface of the printed wiring board in an attitude intersecting the printed wiring board;
a light emitting element mounted on a surface the package substrate;
an electrically conductive base superposed on the end surface of the printed wiring board in an attitude intersecting the printed wiring board;
a multilayered ceramic substrate mounted on a surface of the electrically conductive base, the multilayered ceramic substrate having a ground layer on a front surface of the multilayered ceramic substrate;
a light receiving element mounted on the front surface of the multilayered ceramic substrate;
a cap cooperating with the electrically conductive base for enclosing the multilayered ceramic substrate and the light receiving element;
an electrically conductive body connecting the ground layer to the electrically conductive base; and
terminals attached to a back surface of the multilayered ceramic substrate, the terminals projecting outside the electrically conductive base, the terminals being bonded to front and back surfaces of the printed wiring board outside the electrically conductive base.
